(19) United States
(12) Patent Application Publication
(10) Pub. No.: US 2025/0144956 A1
(43) Pub. Date: May 8, 2025

(54) PEN HOLDER

(71) Applicant: Bleispitz GmbH, Oberhaching (DE)

(72) Inventor: Enno MIEDL, Oberhaching (DE)

(21) Appl. No.: 18/938,951

(22) Filed: Nov. 6, 2024

(30) Foreign Application Priority Data
Nov. 8, 2023 (DE) 10 2023 130 994.3
Jun. 3, 2024 (EM) 015062432-0001
Jun. 3, 2024 (EM) 015062432-0002
Jun. 3, 2024 (EM) 015062432-0003
Jun. 3, 2024 (EM) 015062432-0004
Jun. 3, 2024 (EM) 015062432-0005

(51) Int. Cl. B43K 25/02

(52) U.S. Cl. CPC B43K 25/024

(57) ABSTRACT

A pen holder is provided for storing a first pen or marker, and a second pen or marker. The pen holder comprises a first base body which extends in a first longitudinal direction and delimits a first receiving space for at least partially receiving the first pen, and a second base body which extends in a second longitudinal direction and delimits a second receiving space for at least partially receiving the second pen. A coupling element and a method of using a coupling element are also provided.

### BACKGROUND

### Technical Field

The present disclosure relates to a pen holder for storing a pen as well as to a coupling element and a use of the coupling element.

### Prior Art

In crafts and on construction sites, different pens such as a carpenter's pencil, a felt-tip pen, a ballpoint pen and/or a deep-hole marker are in daily use to carry out marking work and to take notes.

Accordingly, for different tasks different types of pens are used. For marking work, rather the deep-hole marker is used and for taking notes use is made of a conventional ballpoint pen.

It is of particular importance that the different pens are easy to reach and can be used single-handed so as to ensure access to the correct pen at any time, even without looking.

Further, the different pens are intended to be accommodated/fixed on the user in such a way that a loss/misplacement of the pens can be avoided, as particularly pens lying around on the construction site quickly disappear.

For solving this problem, pen holders as they are known from DE 695 06 392 T2, for example, have become established on the market. Those pen holders can be fixed by a clip to a pocket or a belt of the user/operator and enable the user to access the pen single-handed.

It is a drawback of those pen holders that an individual pen holder is required for each pen. In other words, the user has to take along plural different pen holders for plural pens. As a result, the user carries a plurality of pen holders next to each other in a pocket, such as a folding rule pocket or pants pocket, or on a belt.

The plurality of pen holders can have a negative influence on each other. For example, two adjacent pen holders may get caught into each other and may restrict the user's freedom of movement.

Therefore, it is the object of the present disclosure to eliminate or at least reduce the drawbacks of prior art. Concretely, it is the object of the present disclosure to provide a possibility of storing and transporting plural, preferably different, pens safely and easily accessibly on the user.

### SUMMARY

This object is achieved by a pen holder according to the independent claim 1 of the present disclosure. Further, this object is achieved by a coupling element according to the independent claim 11 and a use of the coupling element according to the independent claim 12. Advantageous developments are claimed in the subclaims and/or described as follows.

Concretely, the object is achieved by a pen holder for storing a first pen/marker, specifically a felt-tip pen or paint marker or carpenter's pencil or ballpoint pen or deep-hole marker or mechanical pencil, and a second pen/marker, specifically a felt-tip pen or paint marker or carpenter's pencil or ballpoint pen or deep-hole marker or mechanical pencil, comprising a first, preferably sleeve-shaped, base body which extends in a first longitudinal direction and delimits a first receiving space for at least partially receiving the first pen, and a second, preferably sleeve-shaped, base body which extends in a second longitudinal direction and delimits a second receiving space for at least partially receiving the second pen.

In other words, the object is achieved by the pen holder in the form of a multiple holder, specifically double holder, which is provided and designed to simultaneously receive the first pen and the second pen. The first pen can be different from the second pen. That is, the first pen may have a first writing tip and a first diameter, and the second pen may have a second writing tip and a second diameter, wherein the first writing tip may be different from the second writing tip and/or the first diameter may be different from the second diameter. Of course, the first pin and the second pin may also be identical.

The pen holder comprises the first base body which extends, preferably at least partially cylindrically, in the first longitudinal direction. Alternatively, or additionally, the first base body can have a partially conical and/or frustoconical design. Accordingly, the first base body preferably has a (by far) larger extension in the first longitudinal direction than in a first width direction/radial direction oriented normal to the longitudinal direction. The first base body preferably can be sleeve-shaped or can be designed in sleeve shape. In other words, the first base body may have a kind of tube geometry closed on one side with a relatively thin base body wall. Alternatively, the first base body may have a tube geometry open on both sides. Also, embodiments are conceivable in which the first base body has a substantially rectangular geometry. The first base body and/or first base body wall of the first base body delimits the first receiving space of the first base body.

The first receiving space is accessible/connected to an environment surrounding the pen holder by the first insertion opening. The first insertion opening is formed at one of the ends of the first base body in the longitudinal direction. In particular, the insertion opening can be formed on an end face/front side of the first base body or can substantially constitute the end face/front side.

The insertion opening is the opening through which the first pen can be introduced/inserted/pushed/slid at least partially into the first receiving space. Preferably, the first insertion opening is the only opening which connects the first receiving space to the environment surrounding the pen holder. Alternatively, the first receiving space may include further openings, preferably an opening at an end of the first base body remote from the first insertion opening.

The pen holder further comprises the second base body which extends, preferably at least partially cylindrically, in the second longitudinal direction. Alternatively, or additionally, the second base body can have a partially conical and/or frustoconical design. Accordingly, the second base body preferably has a (by far) larger extension in the second longitudinal direction than in a second width direction/radial direction oriented normal to the second longitudinal direction. The second base body preferably can be sleeve-shaped or can be designed in sleeve shape. In other words, the second base body may have a kind of tube geometry closed on one side with the relatively thin base body wall. Alternatively, the second base body may have a tube geometry open on both sides. Also, embodiments are conceivable in which the second base body has a substantially rectangular geometry. The second base body and/or the base body wall of the second base body delimits the second receiving space of the second base body.

The second receiving space is accessible/connected to the environment surrounding the pen holder by the second insertion opening. The second insertion opening is formed at one of the ends of the second base body in the second longitudinal direction. In particular, the second insertion opening can be formed on an end face/front side of the second base body or can substantially constitute the end face/front side.

The second insertion opening is the opening through which the second pen can be introduced/inserted/pushed/slid at least partially into the second receiving space. The second insertion opening can be the only opening which connects the second receiving space to the environment surrounding the pen holder. Alternatively, the second receiving space may include further openings, preferably an opening at an end of the second base body remote from the second insertion opening.

The first longitudinal direction may be oriented in parallel to the second longitudinal direction. Alternatively, the first longitudinal direction may be not in parallel, such as askew or angled, to the second longitudinal direction.

Therefore, it is the core of the present disclosure to provide a pen holder comprising at least two receiving spaces for simultaneously receiving at least two, preferably different, pens and, thus, to provide a multiple holder, specifically double holder.

Such a design of the pen holder allows the user to take along several pens for different tasks in a safe and easily accessible manner. Accordingly, the plural pens can be stored and transported in a defined arrangement relative to each other.

In a first aspect, the first base body can be designed to be oriented and arranged in a defined way relative to the second base body. In other words, the first base body can be designed to be stationary in relation to the second base body in the pen holder.

In another aspect, the first base body and the second base body can be connected, specifically coupled, or connectable, specifically couplable, to each other, preferably reversibly, via a coupling element.

In other words, the coupling element is preferably provided and designed to connect, preferably positively and/or non-positively or materially, the first base body and the second base body to each other.

Preferably, the coupling element can be detached non-destructively from the first base body and/or from the second base body. Particularly preferred, the coupling element can be mounted to and/or dismantled from the first base body and/or the second base body without tools.

A coupling element of such design allows a modular design of the pen holder. In other words, the pen holder can be formed of different base bodies in a modular way via the coupling element. Accordingly, a plurality of base bodies can be coupled to one another.

In particular, also three, four, five or more base bodies can be coupled or designed with one another.

Also, embodiments are conceivable in which more than one coupling element is formed between the first base body and the second base body. In other words, two or more coupling elements can connect the first base body to the second base body.

As an alternative, the coupling element can be designed materially/integrally/monolithically with the first base body and/or the second base body.

In other words, the coupling element is not limited to an element or an assembly group formed separately by the first base body and the second base body, but can be formed in one part both with the first base body and with the second base body and with all base bodies. The first base body, the second base body and the coupling element can be designed as a materially integral pen holder in an additive manufacturing method, specifically in 3D printing, for example. In particular, also three, four, five or more base bodies can be coupled or formed with one another.

Also, embodiments are conceivable in which the first base body and the second base body are formed in an overall base body. That is, embodiments are conceivable in which the first receiving space and the second receiving space are formed in an overall base body. In such embodiment, portions of the overall base body different from each other are meant by the first base body and the second base body. Of course, also in such embodiment, more than two receiving spaces are conceivable in the overall base body. For example, also three, four, five or more receiving spaces can be formed in the overall base body.

In another aspect, the pen holder, specifically the coupling element of the pen holder, can include a fastening clip, the fastening clip being provided and designed to reversibly fix the pen holder on the user.

In other words, the fastening clip can be formed preferably integrally with the coupling element. The fastening clip can extend optionally in parallel to the first longitudinal direction or in parallel to the second longitudinal direction. The fastening clip may comprise or constitute a spring element and can be provided and designed to exert a clamping force upon a pocket edge, particularly a pants pocket edge or a folding rule edge, a belt or the like of the user and, thus, to fix the coupling element and, therefore, the pen holder with at least the first base body and at least the second base body on the user.

The fastening clip optionally can comprise barbs. That is, the fastening clip can comprise one or more barbs which are provided and designed to get caught. The barbs can be designed, in a preferred embodiment, opposite to each other on an inner side of the fastening clip and on a portion arranged opposite thereto. Preferably, the barbs can be formed alternately on the fastening clip and on the portion.

In another aspect, a refill receptacle provided and designed to receive first refills for the first pen and/or second refills for the second pen can be formed on the coupling element.

In other words, the coupling element can be formed with the refill receptacle, preferably in the form of a refill holder. The refill receptacle can be formed integrally with the coupling element or can be adapted to be fixed/attached to the coupling element. The refill receptacle can include individual refill sheaths for each individual refill. Alternatively, the refill receptacle can have a joint refill receiving space for all refills. The refill receiving space can extend in the first longitudinal direction or in the second longitudinal direction, preferably the refill receptacle can be designed between the first base body and the second base body.

By designing the coupling element with the refill receptacle, the pen holder with the refill receptacle can have a more compact design than when the refill receptacle and the pen holder are formed separately. Further, by designing the refill receptacle on the coupling element, the refill receptacle can be achieved to be easily accessible when carried on the user. Optionally, the refill receptacle can be a replaceable refill receptacle. Further optionally, the refill receptacle can be additionally or alternatively provided and designed to receive spare tips for permanent and/or paint markers.

In another aspect, the first base body can be designed with a first, preferably peripheral, coupling portion, and the second base body can be designed with a second, preferably peripheral, coupling portion, and the coupling element can be provided and designed to engage, preferably positively, the first coupling portion and the second coupling portion, and/or to encompass the first coupling portion and the second coupling portion.

In other words, the first base body can be designed with the first coupling portion and the second base body can be designed with the second coupling portion.

The first coupling portion can be designed in the first longitudinal direction having a preferably first limitation on both sides. The first limitation can be an annular diameter extension of the first base body. In other words, two annular diameter extensions can delimit the first coupling portion in the longitudinal direction.

The second coupling portion can be designed in the second longitudinal direction having a preferably second limitation on both sides. The second limitation can be an annular diameter extension of the second base body. In other words, two annular diameter extensions can delimit the second coupling portion in the longitudinal direction.

Alternatively, the first coupling portion and the second coupling portion can be a latching geometry, such as in the form of a dovetail joint. Further alternatively, the first coupling portion and the second coupling portion can be designed with a thread.

First and second coupling portions designed in such way can help fix the coupling element safely and reversibly to the first base body and/or the second base body. The modular design of the pen holder is further improved by the first coupling portion and the second coupling portion.

In another aspect, the first coupling portion and the second coupling portion may have a geometrically identical structure.

In another aspect, the first base body can have a first central fiber extending in the first longitudinal direction and the second base body can have a second central fiber extending in the second longitudinal direction, wherein the first central fiber can be oriented at an angle with the second central fiber.

In other words, the first base body has the first (imaginary) central fiber which extends in the first longitudinal direction in the first base body. Optionally, the first base body can be rotationally symmetric to the first central fiber. The second base body has the second (imaginary) central fiber which extends in the second longitudinal direction in the second base body. Optionally, the second base body can be rotationally symmetric to the second central fiber. The first central fiber can be oriented at the angle with the second central fiber, i.e. not in parallel to the second central fiber.

Preferably, the angle can be an acute angle. The angle can concretely range from 1° to 30°, preferably from 5° to 15°. In one embodiment, the first central fiber can be oriented askew to the second central fiber.

Insertion and removal of the first pen into/from the first receiving space and/or insertion and removal of the second pen into/from the second receiving space can be facilitated by forming the angle between the first central fiber and the second central fiber or, alternatively, by the skewed orientation.

In another aspect, the first base body can include the first insertion opening for inserting the first pen into the first receiving space of the first base body at a first base body end, and the second base body can include the second insertion opening for inserting the second pen into the second receiving space at a second base body end, the first insertion opening and the second insertion opening being arranged offset against each other in the first longitudinal direction and/or in the second longitudinal direction.

In other words, the first insertion opening of the first base body can be arranged in a first plane, and the second insertion opening of the second base body can be arranged in a second plane. The first plane may be different from the second plane.

Preferably, the first plane and the second plane can intersect in an (imaginary) line of intersection.

In yet other words, the first insertion opening can be arranged in the first longitudinal direction and/or in the second longitudinal direction stepped towards the second insertion opening.

By appropriately arranging the first insertion opening and the second insertion opening, the reachability of and, resp., the access to the first pen in the first base body and the reachability of and, resp., the access to the second pen in the second base body can be improved.

In another aspect, the first insertion opening and/or the second insertion opening can have or be an insertion funnel, with a cross-sectional opening of the insertion funnel widening, preferably conically, starting from the first and/or second receiving space.

That is, the first insertion opening and/or the second insertion opening can be a conical tube segment and can taper from the environment surrounding the pen holder to the receiving space.

Of preference, the insertion funnel can be designed by a reduction/variation of the wall thickness of the first base body and/or the second base body formed partially, preferably linearly in the first longitudinal direction and/or in the second longitudinal direction.

An insertion funnel of such design can help facilitate insertion of the first pen into the first base body and/or insertion of the second pen into the second base body.

In another aspect, the first base body can have a closed writing tip receptacle for receiving, preferably airtightly, a first writing tip of the first pen, and the second base body can have an open writing tip receptacle.

That is, the first base body may be designed with exclusively the first insertion opening and may be provided and designed to receive the first writing tip of the first pen airtightly. The second base body can be designed with the second insertion opening and a second exit opening. The second exit opening can be formed at the end of the second base body remote from the second insertion opening. The second exit opening can be provided and designed to connect the second writing tip of the second pen to the environment surrounding the pen holder.

Such design can help protect the first pen, which preferably is a felt-tip pen or a paint marker or a deep-hole marker and, accordingly, can dry when in contact with air, against drying. Moreover, the second pen, which preferably is a pencil or ballpoint pen, can be kept dry, and moisture or chips and/or any other staining can get out of the second exit opening from the second base body.

In a further aspect, a first fixing spring can be formed in the first receiving space and/or a second fixing spring can be formed in the second receiving space to non-positively fix the first pen in the first receiving space and, resp., the second pen in the second receiving space.

In other words, both the first receiving space and the second receiving space can be designed with a fixing element in the form of the first fixing spring or the second fixing spring. Preferably, the first fixing spring braces the first pen against a first base body portion of the first base body arranged diametrically opposite to the first fixing spring. Further preferably, the second fixing spring braces the second pen against a second base body portion of the second base body arranged diametrically opposite to the second fixing spring.

Preferably, the first fixing spring and/or the second fixing spring is designed as a leaf spring. Alternatively, other embodiments such as a molded spring, flat spiral spring, barrel spring or annular spring are possible.

Due to such a fixing spring, the first pen can be fixed non-positively in the first receiving space of the first base body and/or the second pen can be fixed non-positively in the second receiving space of the second base body.

In another aspect, the first base body and/or the second base body of the pen holder can be designed to have a sealing portion, preferably in the form of a separately formed sealing element.

In other words, in the first receiving space and/or in the second receiving space the at least one sealing portion can be formed or arranged. The sealing portion is provided and designed to make radially circumferentially sealing contact with the respective pen that is inserted in the receiving space through the insertion opening, wherein the sealing portion preferably can make sealing contact with at least two different pen geometries.

In yet other words, the sealing portion can make radially circumferentially sealing contact with both the first pen geometry having the first large diameter and the second pen geometry having the second smaller diameter.

The sealing portion can be in the form of a coherent sealing portion. Alternatively, the sealing portion can be segmented. As a further alternative, the sealing portion can be designed in several parts spaced apart in the longitudinal direction. That is, the sealing portion can alternatively be formed of plural individual sealing portions spaced apart from each other.

In a configuration as a coherent sealing portion, the sealing portion can include an (elastic) tube or funnel geometry tapering, preferably linearly, from the insertion opening in the longitudinal direction. In other words, the sealing portion can have or be a tapered sealing geometry.

In an alternative configuration, the sealing portion can have several sealing segments arranged sequentially one behind the other in the longitudinal direction, each sealing segment being provided and designed to seal and thus to make radially circumferentially sealing contact with a defined diameter or a defined diameter range. The sequentially arranged sealing segments can be arranged one behind the other without spacing in the longitudinal extension of the first and/or second base body. Alternatively, the sequentially arranged sealing segments can be arranged in the base body spaced apart one behind the other in the longitudinal direction. Preferably, the defined diameters/diameter ranges, i.e. the diameters and/or diameter ranges in which the respective sealing segments seal the pen, of the sequential sealing segments are tapered/reduced from the insertion opening.

In another aspect, the sealing portion can be adaptable to a diameter of the pen, preferably by a replaceable/switchable changing device/adapter device, to make radially sealing contact with the pen or the different pens having the different diameters by means of different sealing portions.

That is, the changing device is designed to insert or render insertable different sealing portions, i.e. sealing portions having different defined diameters, into the receiving space of the base body. The different sealing portions can be a fixed part of the changing device, for example in the form of a drum or a magazine or a grid. As an alternative, the different sealing portions can be designed separately from the changing device and can be inserted into the receiving space via the changing device.

In a further aspect, the base body, specifically the second base body, can have a preferably ramp-shaped latching edge which extends radially circumferentially outwards away from the base body and is provided and designed to be gripped by a clip of a pen so as to prevent the pen from sliding out of the base body. The ramp-shaped latching edge can radially enlarge preferably in an extension in a direction away from the insertion opening.

In a further aspect, an alternative base body can be designed in the form of a pen holder to annularly fix or clamp a pen. That is, the alternative base body may be designed as a pen holder extending in a longitudinal direction in the form of a ring or tube geometry which surrounds or delimits the receiving space for receiving the pen in annular or tubular shape. A clamping element is formed on an inner wall of the receiving space of the pen holder to frictionally or non-positively fix a pen, specifically a pencil.

In one aspect, the clamping element of the pen holder can be designed as at least one elastic tubular (shell) portion or can comprise at least one elastic tubular (shell) portion.

Particularly preferred, the at least one elastic tubular (shell) portion can surround the pen in a mounted state by at least 180°, particularly by at least 270°.

Preferably, the pen holder can be formed in one piece of plastic material, preferably as an injection molded part.

Further preferred, the pen holder can comprise a coupling portion and two stops delimiting the coupling portion, the coupling portion being provided and designed to be fixed by a coupling element.

For example, the coupling portion can be gripped by a recessed grip of a coupling element.

The object of the present disclosure is further achieved by a coupling element for, preferably reversibly, coupling or fixing thereto a first, preferably sleeve-shaped, base body that extends in a first longitudinal direction and delimits a first receiving space for at least partially receiving a first pen, and a second, preferably sleeve-shaped, base body that extends in a second longitudinal direction and delimits a second receiving space for at least partially receiving a second pen.

In the embodiment described here, each of the first base body and the second base body can be individual pen holders, viz. pen holders for one pen each, and the coupling element can connect plural, preferably also three, four, five or more, of those individual pen holders to each other and fix the individual pen holders relative to each other in a geometrically defined manner.

In particular in one embodiment in which each of the base bodies is an individual pen holder, an (additional) fastening clip on the coupling element can be dispensed with, and the user can make use of at least one of the fastening clips of the individual pen holders.

The coupling element can further be designed in one piece or monolithically.

The coupling element can be designed to have an elastic coupling portion. The elastic coupling portion can comprise at least one elastic tubular shell-type portion that extends radially about more than 180°. That is, the elastic coupling portion can be a tubular shell-type portion having an insertion opening.

The insertion opening can be a slit which can be elastically widened to insert the base body into the coupling element.

As a matter of course, in this case the slit can also be elastically widened so as to remove the base body from the coupling element.

When fixed, the elastic coupling element can surround the base body radially by more than 180°, preferably by more than 225°, particularly preferred by more than 270°.

Further, the object of the present disclosure is achieved by a use of a coupling element, preferably according to any one of the above aspects, for, preferably reversibly, coupling and/or fixing a first, preferably sleeve-shaped, base body which extends in a first longitudinal direction and delimits a first receiving space for at least partially receiving a first pen, and a second, preferably sleeve-shaped, base body which extends in a second longitudinal direction and delimits a second receiving space for at least partially receiving a second pen.

It is understood that even, preferably different, pens can be arranged in the two base bodies according to the disclosure.

In another aspect to be claimed also independently, if necessary, the present disclosure relates to a deep-hole marker which can be inserted into the pen holder according to the disclosure, comprising a grip portion, a deep-hole marking portion and a sleeve which can be reversibly fixed on the deep-hole marking portion. Due to the sleeve, it can be switched between a first deep-hole marking position and a second deeper deep-hole marking position. The deep-hole marker is provided and designed to be introduced into the first receiving space of the first base body or into the second receiving space of the second base body.

In the first deep-hole marking position, the sleeve is fixed on the deep-hole marking portion and/or the sleeve encloses a first defined portion of the deep-hole marking portion, and a second defined portion of the deep-hole marking portion is exposed. In the second deep-hole marking position, the sleeve is separated from the deep-hole marking portion and the first defined portion and the second defined portion are exposed.

Such a design of the deep-hole marker allows to mark both deep positions to be marked and very deep positions to be marked.

Preferably, the sleeve can be fixable to the grip portion via a thread. Alternatively, the sleeve can be fixed on the deep-hole marking portion via a spring element or the like.

In one aspect, a longitudinal extension of the first defined portion can substantially correspond to a longitudinal extension of the second defined portion. As a matter of course, also embodiments are conceivable in which the longitudinal extension of the first defined portion differs from the longitudinal extension of the second defined portion. However, it is essential that both the first defined portion and the second defined portion, each considered per se, represent deep-hole marking positions and, preferably, each of them is larger than 1 cm.

### BRIEF DESCRIPTION OF THE FIGURES

FIG. 1 is a perspective view of a pen holder according to the disclosure with a first pen and a second pen.

FIG. 2 is a first lateral view of the pen holder according to the disclosure with the first pen and the second pen.

FIG. 3 is a second lateral view of the pen holder according to the disclosure with the first pen and the second pen.

FIG. 4 is a third lateral view of the pen holder according to the disclosure with the first pen and the second pen.

FIG. 5 is a fourth lateral view of the pen holder according to the disclosure with the first pen and the second pen.

FIG. 6 is a section view of the pen holder according to the disclosure with the first pen and the second pen.

FIG. 7 is a perspective representation of a first base body of the pen holder according to the disclosure.

FIG. 8 is a first lateral view of the first base body of the pen holder according to the disclosure.

FIG. 9 is a second lateral view of the first base body of the pen holder according to the disclosure.

FIG. 10 is a plan view of the first base body of the pen holder according to the disclosure.

FIG. 11 is a first lateral view of the second base body of the pen holder according to the disclosure.

FIG. 12 is a second lateral view of the second base body of the pen holder according to the disclosure.

FIG. 13 is a perspective view of the second base body of the pen holder according to the disclosure.

FIG. 14 is a plan view of the second base body of the pen holder according to the disclosure.

FIG. 15 is a perspective representation of a first portion of a coupling element of the pen holder according to the disclosure.

FIG. 16 is a perspective representation of a second portion of the coupling element of the pen holder according to the disclosure.

FIG. 17 is a perspective representation of an alternative coupling element.

FIG. 18 is a perspective representation of an alternative pen holder.

FIG. 19 is a perspective view of an alternative second base body of the pen holder.

FIG. 20 is a first view of an alternative base body in the form of a pen cup for the pen holder according to the disclosure.

FIG. 21 is a second view of the pen cup for the pen holder according to the disclosure.

FIG. 22 is a first view of the pen holder with two of the pen cups.

FIG. 23 is a second view of the pen holder with two of the pen cups.

FIG. 24 is a third view of the pen holder with two of the pen cups and two pencils inserted in the pen holder.

FIG. 25 shows a deep-hole marker in a first configuration, the deep-hole marker being insertable into the pen holder according to the disclosure.

FIG. 26 shows the deep-hole marker in a second configuration, the deep-hole marker being insertable into the pen holder according to the disclosure.

### DESCRIPTION OF THE EMBODIMENTS

Hereinafter embodiments of the present disclosure will be described on the basis of the associated Figures.

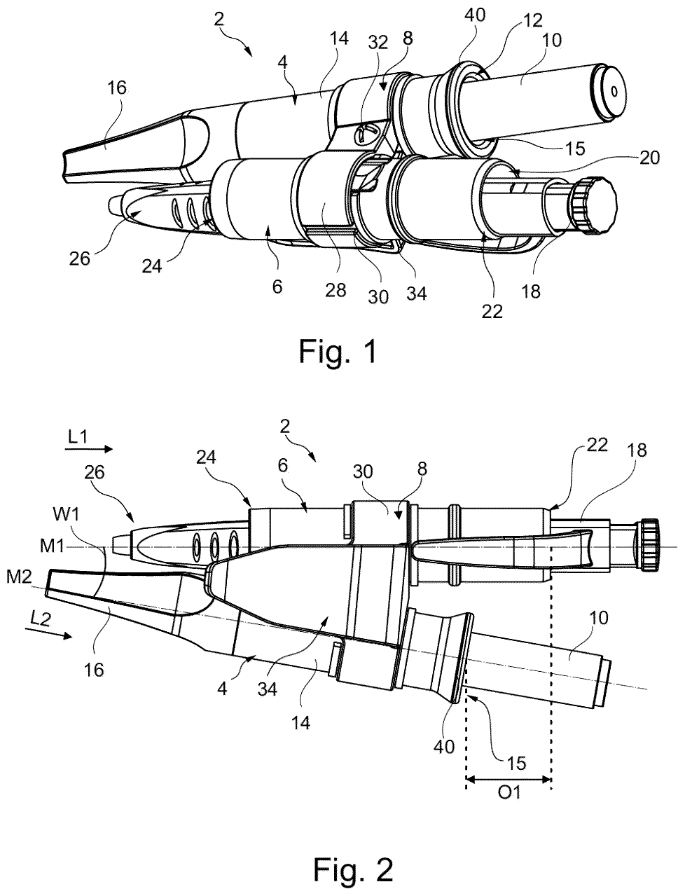

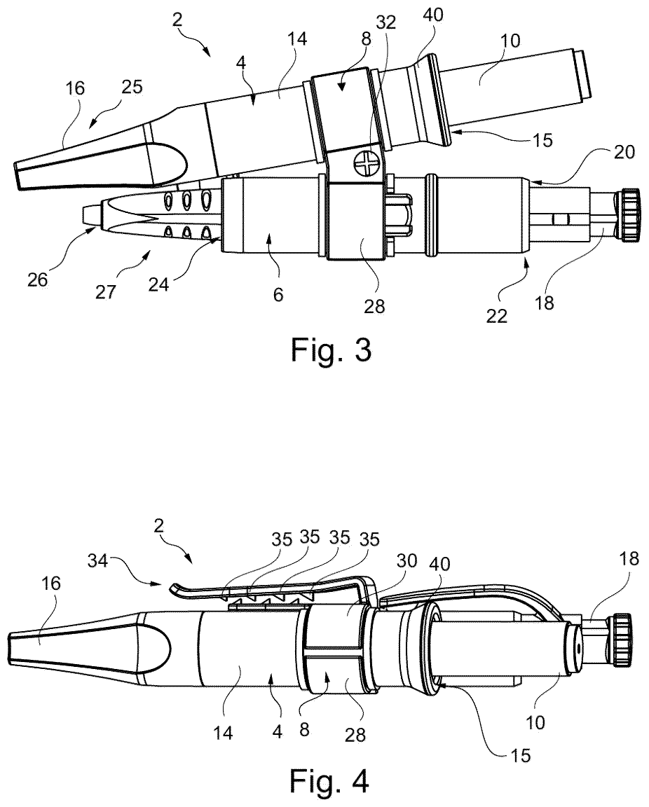

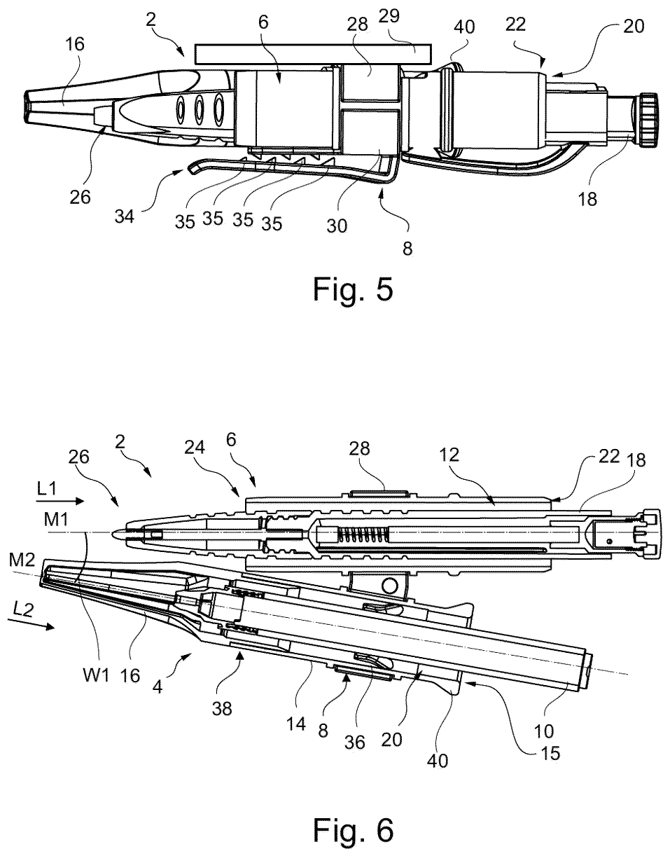

FIG. 1 illustrates a pen holder 2 according to the disclosure in a perspective view. FIG. 2 illustrates the pen holder 2 according to the disclosure in a first lateral view, FIG. 3 illustrates the pen holder 2 according to the disclosure in a second lateral view opposite to the first lateral view, FIG. 4 illustrates the pen holder 2 according to the disclosure in a third lateral view, and FIG. 5 illustrates the pen holder 2 according to the disclosure in a fourth lateral view opposite to the third lateral view with an additional refill holder 29.

In the following, the general structure of the pen holder 2 according to the disclosure is described on the basis of FIGS. 1 to 5.

The pen holder 2 according to the disclosure comprises the first sleeve-shaped base body 4 and the second tubular base body 6. The first base body and the second base body are positively connected to each other via a coupling element 8.

The first base body 4 is provided and designed to receive a first pen 10 in a first receiving space 12. The first base body 4 extends in a first longitudinal direction L1. The first base body 4 comprises a first substantially tubular portion 14 and a second tapered portion 16. The first portion 14 is formed in one piece. The second portion 16 is formed in one piece.

The first portion 14 of the first base body 4 has a substantially circular first insertion opening 15 on a first end face. The first insertion opening 15 is provided and designed to insert the first pen 10 at least partially into the first receiving space 12.

The second base body 6 is provided and designed to receive a second pen 18 in a second receiving space 20. The second base body 6 extends in a second longitudinal direction L2. The second base body 6 has a substantially tubular design. The second base body 6 has a substantially circular second insertion opening 22 on a first end face. The second insertion opening 22 is provided and designed to insert the second pen 18 at least partially into the second receiving space 20. The second base body 6 has a substantially circular (second) exit opening 24 on a second end face that is remote from the first end face. The exit opening 24 is provided and designed to release a second writing top 26 of the second pen 18.

In other words, the first base body 4 having the first receiving space 12 is provided and designed to receive the first pen 10, which is a pen 10 that can dry when in contact with air, airtightly, and the second base body 6 having the second receiving space 20 is provided and designed to receive the second pen 18, which is a pen 18 that cannot dry when in contact with air, with a free second writing tip 26.

In yet other words, the first base body 4 comprises a first closed writing tip receptacle 25 and the second base body 6 comprises a second open writing tip receptacle 27.

The first base body 4 and the second base body 6 are positively connected to each other via the coupling element 8. The coupling element 8 in the embodiment shown here is a two-part screw clamp. That is, the coupling element 8 comprises a first coupling element portion 28 and a second coupling element portion 30 which positively connect the first base body 4 and the second base body 6 to each other. Between the first base body 4 and the second base body 6, the first coupling element portion 28 and the second coupling element portion 30 are screw-connected to each other using a screw 32. The second coupling element portion 30 is designed to have a fastening clip 34. The fastening clip 34 is provided and designed to fix the pen holder 2 on a belt, a (pants) pocket, a folding rule pocket or on any other suitable object of a user of the pen holder 2.

The fastening clip 34 is designed with alternately opposed barbs 35 to improve a fit of the pen holder on the user.

Alternatively to the shape of the two-part coupling element 8 shown here, also a one-part design of the coupling element 8 is conceivable. In other words, the coupling element 8 can be designed with a latching mechanism in which the first base body 4 and the second base body 6 can engage.

The first base body 4 has a first central fiber M1. The second base body 6 has a second central fiber M2. The first central fiber M1 and the second central fiber M2 span a plane and are oriented at an angle W1 relative to each other. The angle W1 is an acute angle. Preferably, the angle W1 is between 5° and 30°. As an alternative, the central fibers M1 and M2 of the two base bodies 4, 6 can also be arranged askew to each other. Preferably, the two central fibers M1 and M2 are not in parallel.

The first insertion opening 15 of the first base body 4 is designed to be spaced from the second insertion opening 22 of the second base body 6 in the first longitudinal direction L1 and, resp., the second longitudinal direction L2. Concretely, the first insertion opening 15 is spaced apart from the second insertion opening 22 by an opening distance O1. The opening distance O1 can preferably amount to 0.5 cm to 5 cm.

In FIG. 5, a refill receptacle in the form of a refill holder 29 is formed on the coupling element 8 to receive refills for the first pen 10 and for the second pen 18. The refill holder 29 in the embodiment shown here is formed integrally with the coupling element 8. As an alternative, the refill holder 29 can be adapted to be coupled reversibly to the coupling element 8.

FIG. 6 illustrates a section across the pen holder 2. The first base body 4 comprises the first fixing spring 36 to reversibly fix the first pen 10 in the first receiving space 12.

The first portion 14 of the first base body 4 and the second portion 16 of the first base body 4 are connected/coupled to each other in a connecting area 38. The connecting area 38 can be formed as a non-positive and/or positive connection between the first portion 14 and the second portion 16, the second portion 16 being partly inserted in the first portion 14. That is, the first portion 14 and the second portion 16 can be glued, crimped, shrunk, welded or the like to each other. For this purpose, in the connecting area 38 the first portion 14 is formed with a reduced outer diameter so that an outer contour of the first base body 4 is designed substantially continuously in the connecting area 38. As a matter of course, also the second portion 16 can be partly inserted in the first portion 14 or the second portion 16 and the first portion 14 can be connected to each other on end faces contacting each other.

Further, embodiments are conceivable in which the connecting area 38 is designed as a reversibly connected connecting area 38 so that the latter can be connected and separated by the user. Preferably, the connecting area 38 can be designed with a bayonet lock for this purpose.

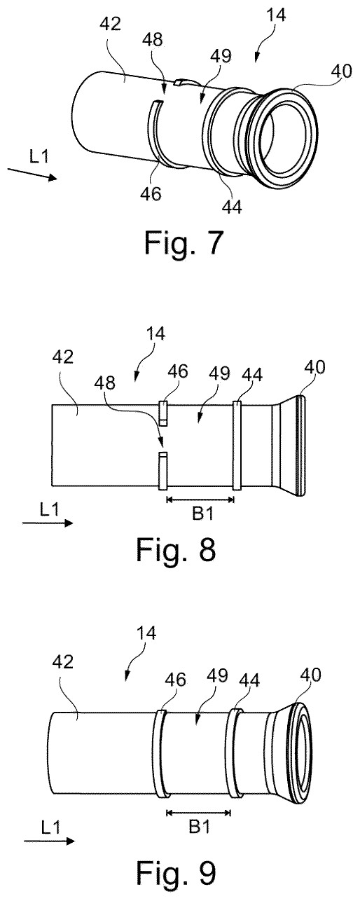

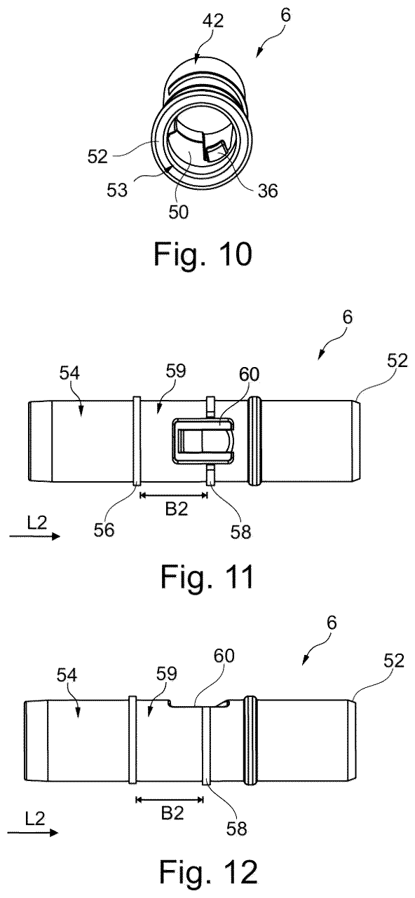

Hereinafter, the first portion 14 of the first base body 4 will be explained in detail based on FIGS. 7 to 10.

The first portion 14 extends in the first longitudinal direction L1. At a first end of the first portion 14, the first insertion opening 15 is formed. The first insertion opening 15 in the embodiment shown here is formed to have a circumferential funnel-shaped grip shoulder 40. The grip shoulder 40 is provided and designed to facilitate removal of the first pen 10 from the first base body 4. Concretely, the user can grasp the first pen 10, such as with an index finger and a middle finger, and press with the thumb of the same hand against the grip shoulder 40 to overcome a latching force by which the first pen 10 is latched in the first base body 4.

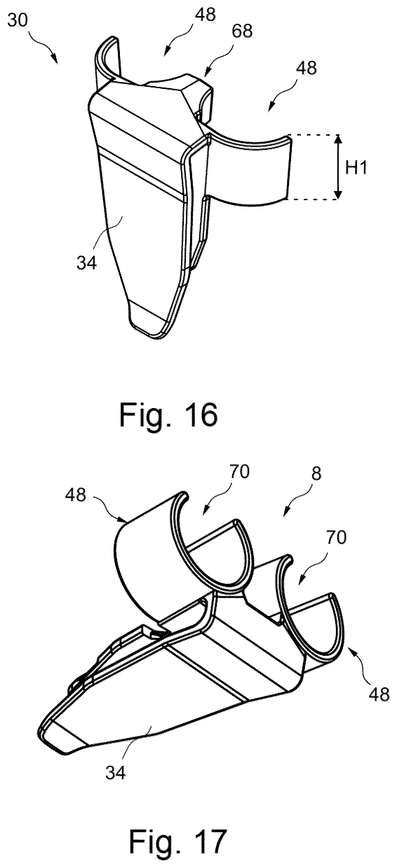

The first portion 14 of the first base body 4 further comprises a first outer circumferential surface 42. On the first outer circumferential surface 42, a first stop 44 and a second stop 46 are annularly formed. The first stop 44 is formed spaced apart from the second stop 46 in the first longitudinal direction L1. Concretely, the first stop 44 is formed spaced apart from the second stop 46 by a first distance B1, wherein the distance B1 corresponds to a first height H1 of a recessed grip 48 of the coupling element 8 (see FIG. 15 and FIG. 16). The second stop 46 is designed with an interruption 57 in the circumferential direction.

Between the first stop 44 and the second stop 46, a first coupling portion 49 is formed. The first coupling portion 49 is provided and designed to be gripped by the coupling element 8. The first stop 44 and the second stop 46 are provided and designed to fix and/or delimit the coupling element 8 in the first longitudinal direction L1.

At a first inner circumference 50 of the first portion 14, the first fixing spring 36 is formed materially with the first portion 14.

Adjacent to the first insertion opening 15, an insertion funnel 53 extends into the inner circumference 50.

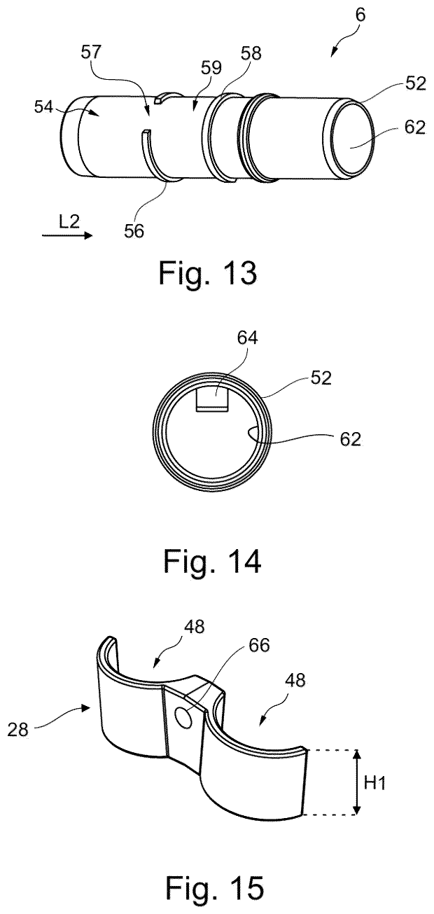

Hereinafter, the second base body 6 will be explained in detail on the basis of the FIGS. 11 to 14.

The second base body 6 extends substantially tube-shaped in the second longitudinal direction L2. At a first end of the second base body 6, the second insertion opening 22 is formed. The second insertion opening 22 is formed with a chamfer 52 in the embodiment shown here. Further, the second base body 6 comprises a second outer circumferential surface 54. On the second outer circumferential surface, a third stop 56 and a fourth stop 58 are formed annularly. The third stop 56 is formed spaced apart from the fourth stop 58 in the second longitudinal direction L. Concretely, the third stop 56 is formed spaced apart from the fourth stop 58 by a second distance B2, the distance B2 corresponding to the distance B1 and to the first height H1 of the recessed grip 48 of the coupling element 8. The third stop 56 is designed with an interruption 57. A wall recess 60 is formed in the second base body 6.

A second coupling portion 59 is formed between the third stop 56 and the fourth stop 58. The second coupling portion 59 is provided and designed to be gripped by the coupling element 8. The third stop 56 and the fourth stop 58 are provided and designed to fix and/or to limit the coupling element 8 in the second longitudinal direction L2.

On a second inner circumference 62, a second fixing spring 64 is formed in one piece with the second base body 6 to fix the second pen 18 in the second base body 6.

FIG. 15 illustrates the first coupling element portion 28 of the coupling element 8. The first coupling element portion 28 substantially consists of the two interconnected recessed grips 48. Each of the recessed grips 48 is a tubular shell segment. An inside radius of the recessed grip 48 substantially corresponds to an outside radius of the first coupling portion 49 and an outside radius of the second coupling portion 59. Of course, also embodiments are conceivable in which the recessed grips have different inside diameters and are adjusted to different outside radii of the first coupling portion 49 and the second coupling portion 59. Further alternatively, the recessed grips can have a flexible design so that in a predetermined range they can adapt to different outside radii.

A screw hole 66 is formed between the two recessed grips 48 to receive the screw 32 which connects the first coupling element portion 28 to the second coupling element portion 30.

FIG. 16 illustrates the second coupling element portion 30. The latter substantially corresponds to the first coupling element portion 28 so that hereinafter only differences from the first coupling element portion 28 will be discussed. The second coupling element portion 30 in addition comprises the fastening clip 34 that is formed centrally between the recessed grips. The second coupling element portion 30 is formed symmetrically to a plane of symmetry of the fastening clip 34. Instead of the screw hole 66, the second coupling element portion 30 comprises a blind hole 68 into which the screw 32 can be screwed to fix the first coupling element portion 28 to the second coupling element portion 30 and, thus, to receive and fix the first base body 4 and the second base body 6 positively and non-positively in the coupling element 8.

FIG. 17 illustrates the coupling element 8 in an alternative embodiment. The coupling element 8 of the alternative embodiment substantially corresponds to the coupling element 8 of the first embodiment which was explained on the basis of FIG. 15 and FIG. 16. In the following, only the differences of the alternative embodiment from the first embodiment of the coupling element 8 will be discussed.

The coupling element 8 of the alternative embodiment is formed in one piece. That is, the recessed grips 48 of the coupling element 8 of the alternative embodiment are designed as elastic tubular (shell) portions. The tube portions have a circumferential extension of more than 180° and an insertion gap 70 which is formed in the tube portion in a longitudinal extension of the tube portion. The first coupling portion 49 and/or the second coupling portion 59 can be introduced into the recessed grips 48 by elastically bending open/widening the insertion gap 70. That is, the coupling element 8 in the alternative embodiment is designed with elastically deformable recessed grips 48 which are provided and designed to partially circumferentially contact the first coupling portion 49 and/or the second coupling portion 59.

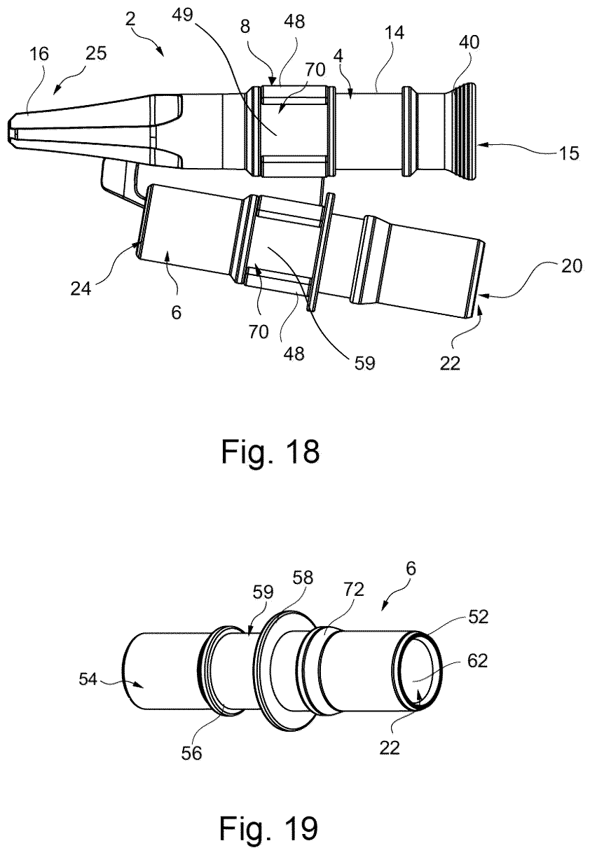

FIG. 18 illustrates the pen holder 2 in an alternative embodiment. In the following, only differences from the first embodiment described on the basis of FIG. 1 to FIG. 3 will be discussed.

The pen holder 2 of the alternative embodiment comprises the coupling element 8 of the alternative embodiment. As a matter of course, also the pen holder 2 of the alternative embodiment can be designed with a refill receptacle 29. In the alternative embodiment shown in FIG. 18, an alternative second base body 6 is formed (see also FIG. 19). The alternative second base body 6 substantially corresponds to the second base body 6 of the first embodiment. The alternative second base body 6 has a disk-shaped fourth stop 58. That is, the fourth stop 58 of the alternative embodiment has a larger radial extension than the fourth stop 58 of the first embodiment.

The alternative second base body 6 further comprises a latching edge 72. The latching edge 72 is a (further) stop which is provided and designed to reversibly receive and/or fix a clip of a pen so that the pen cannot slide out of the second base body. The latching edge 72 for this purpose has a slope descending towards the second insertion opening 22 which slope facilitates fixation of the pen and/or the clip of the pen to the second base body 6.

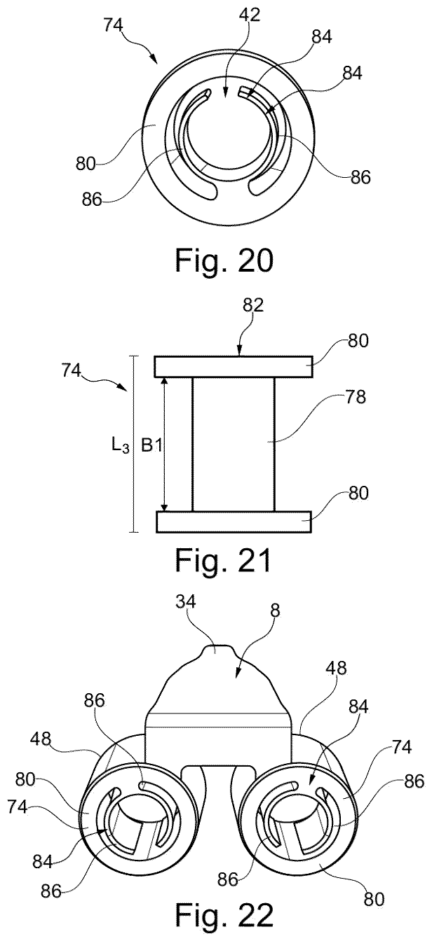

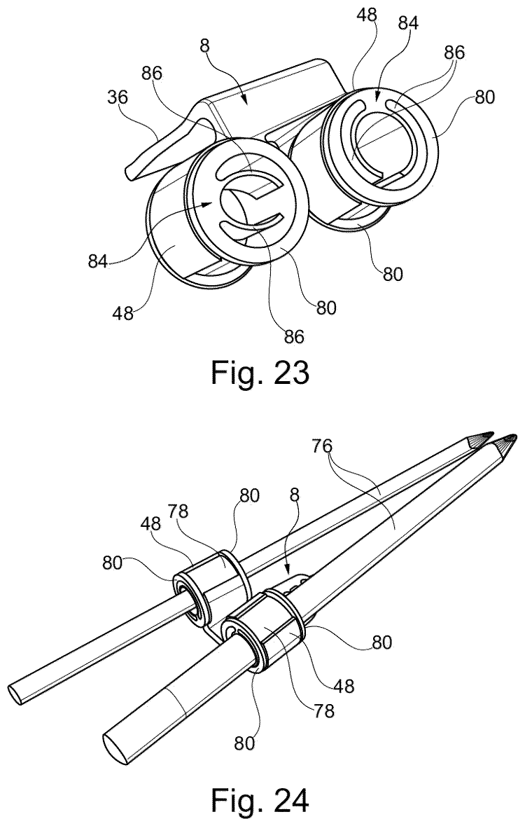

Hereinafter, an alternative base body in the form of a pen cup 74 for the pen holder 2 will be explained on the basis of FIGS. 20 to 24. Accordingly, FIG. 20 and FIG. 21 show the pen cup 74 individually and FIG. 22 and FIG. 23 show two pen cups 74 inserted/clamped in a coupling element 8 so that a pen holder 2 is formed. The coupling element 8 corresponds to the coupling elements 8 already described in detail on the basis of the further embodiments so that the coupling element 8 will not be described again.

FIG. 24 illustrates the pen holder 2 with two of the pen cups 74, with one pencil 76 being inserted in each pen cup 74.

The pen cup 74 is substantially tube-shaped. Concretely, the pen cup 74 is formed with a coil-shaped external geometry and comprises a third coupling portion 78 which is provided and designed to be gripped by recessed grips 48 of the coupling element 8. The third coupling portion 78 is delimited in the longitudinal direction above and below by a respective fifth stop 80. The first distance B1 is formed between the two fifth stops 80. In the pen cup 74 a third receiving space 82 is designed which is accessible from the upper side and the lower side and is provided and designed to receive at least partially a pen (pencil). In other words, the third receiving space 82 is tube-shaped. In the third receiving space 82, a fixing clamp 84 is formed. The fixing clamp 84 is designed as an elastic tubular (shell) portion or consists of elastic tubular (shell) portions which is/are provided and designed to encompass and elastically clamp the pencil 76 radially by more than 180°, wherein the pencil 76 can be removed from and/or inserted into the pen cup 74 in the longitudinal direction through the upper side and/or the lower side.

That is, the fixing clamp 84 forms an elastic clamping element having preferably two clamping arms 86 which extend inwards from a pen cup inner wall 86 of the receiving space 82. The fixing clamp 84 may have a (circular) round or elliptical cross-sectional geometry.

As a matter of course, the pen cup 74 can be inserted with the first base body 4 and/or the second base body 6 into a coupling element and can form a pen holder 2.

A third longitudinal extension L3 of the pen cup 74 is insignificantly larger than the first width B1. Concretely, the third longitudinal extension L3 is larger by twice the longitudinal thickness of the fifth stop 80 than the first width B1.

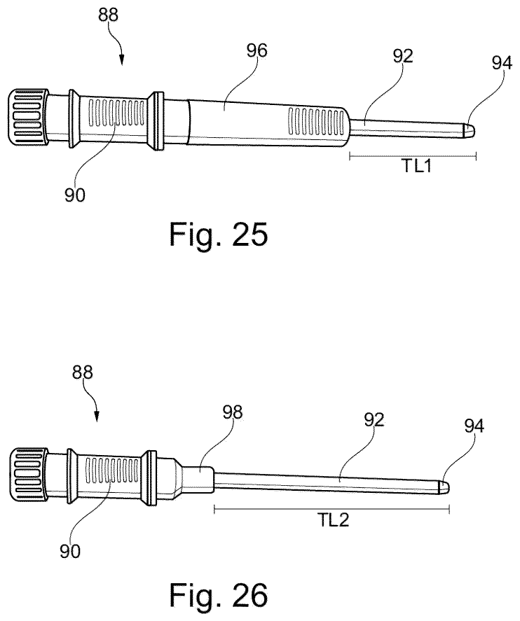

FIG. 25 and FIG. 26 illustrate a deep-hole marker 88 which can be inserted into the pen holder 2. Concretely, the deep-hole marker can be inserted into the first receiving space 12 of the first base body 4 or into the second receiving space 20 of the second base body 6. The pen holder comprises a grip portion 90 and a deep-hole marking tip 92 at the end of which a writing tip 94 is formed. A sleeve 96 is screwed to the grip portion 90 in the direction of the writing tip 94. Concretely, the sleeve 96 is screwed to a thread 98 formed on the grip portion 90.

In the first state shown in FIG. 25, the deep-hole marker 88 is a conventional deep-hole marker 88 and is provided and designed to mark holes up to a first depth corresponding to a first deep-hole marker tip length TL1.

In the second state shown in FIG. 26, the deep-hole marker 88 is an extended deep-hole marker 88 and is provided and designed to mark holes up to a second depth corresponding to a second deep-hole marker tip length TL2. The second depth is considerably larger than the first depth. Preferably, the second depth can be twice as large as the first depth.

In order to switch from the first state to the second state, the sleeve 96 can be unscrewed from the grip portion 90. In order to switch correspondingly from the second state to the first state, the sleeve can be screwed onto the grip portion 90. As an alternative, other fixing options of the sleeve on the grip portion 90 or the deep-hole marker tip 92 are conceivable. One example is a clamping joint or latching hooks.

1. A pen holder for storing a first pen or marker, and a second pen or marker, the pen holder comprising:
a first base body which extends in a first longitudinal direction and delimits a first receiving space for at least partially receiving the first pen, and
a second base body which extends in a second longitudinal direction and delimits a second receiving space for at least partially receiving the second pen.

2. The pen holder according to claim 1, wherein the pen holder is formed in one piece or in several parts.

3. The pen holder according to claim 1, wherein the first base body is connected or connectable to the second base body via a coupling element.

4. The pen holder according to claim 3, wherein the coupling element has a fastening clip which is provided and designed to reversibly fix the pen holder to a user.

5. The pen holder according to claim 3, wherein a refill receptacle which is provided and designed to receive first refills for the first pen and/or second refills for the second pen and/or spare tips for permanent and/or paint markers is formed on the coupling element.

6. The pen holder according to claim 3, wherein the first base body is designed with a first coupling portion, and the second base body is designed with a second coupling portion, and the coupling element is provided and designed to engage the first coupling portion and the second coupling portion.

7. The pen holder according to claim 1, wherein the first base body has a first central fiber extending in the first longitudinal direction and the second base body has a second central fiber extending in the second longitudinal direction, the first central fiber being oriented at an angle or askew to the second central fiber.

8. The pen holder according to claim 1, wherein the first base body includes, at a first base body end, a first insertion opening for inserting the first pen into the first receiving space of the first base body, and the second base body includes, at a second base body end, a second insertion opening for inserting the second pen into the second receiving space of the second base body, the first insertion opening and the second insertion opening being arranged offset against each other in the first longitudinal direction and/or in the second longitudinal direction.

9. The pen holder according to claim 8, wherein the first insertion opening and/or the second insertion opening has or is an insertion funnel, wherein a cross-sectional opening of the insertion funnel widens from the first and/or second receiving space.

10. The pen holder according to claim 1, wherein the first base body includes a closed writing tip receptacle for receiving, a first writing tip of the first pen and the second base body includes an open writing tip receptacle.

11. The pen holder according to claim 1, wherein in the first receiving space a first fixing spring is formed and/or in the second receiving space a second fixing spring is formed to non-positively fix the first pen in the first receiving space and/or the second pen in the second receiving space.

12. The pen holder according to claim 1, comprising a plurality of base bodies each of which extends in a longitudinal direction associated with the specific base body and each of which delimits a receiving space associated with the respective base body for at least partially receiving an associated pen.

13. A coupling element for fixing thereto a first base body and a second base body, the first base body extending in a first longitudinal direction and delimiting a first receiving space for at least partially receiving a first pen, and the second base body extending in a second longitudinal direction and delimiting a second receiving space for at least partially receiving a second pen.

14. A method of using a coupling element comprising providing a coupling element for coupling at least a first base body and a second base body, the first base body extending in a first longitudinal direction and delimiting a first receiving space for at least partially receiving a first pen, and the second base body extending in a second longitudinal direction and delimiting a second receiving space for at least partially receiving a second pen.
